(19) United States
(12) Patent Application Publication
(10) Pub. No.: US 2022/0002495 A1
(43) Pub. Date: Jan. 6, 2022

(54) WEAR-RESISTANT UNISOLE HAVING IMPROVED TRACTION

(71) Applicant: Under Armour, Inc., Baltimore, MD (US)

(72) Inventors: Monibert Narito Gaba, Baltimore, MD (US); Frederick J. Dojan, Baltimore, MD (US); Jet Lei, Baltimore, MD (US)

(21) Appl. No.: 16/921,734

(22) Filed: Jul. 6, 2020

(51) Int. Cl. C08G 77/442; C08L 53/00; A43B 13/04; C08J 3/24; C08K 5/00; C08K 5/42

(52) U.S. Cl. CPC C08G 77/442; C08L 53/00; A43B 13/04; C08K 5/42; C08K 5/0075; C08K 5/0025; C08J 3/24

(57) ABSTRACT

In one embodiment, a composition comprising the reaction product of an olefin block copolymer, a silicone polymer, a blowing agent, and a crosslinking agent. Also, a unisole for an article of footwear comprising the foamed composition and having ground-engaging protrusions. The composition provides an optimized balance between coefficient of traction and durability.

### BACKGROUND

The present application relates generally to unisoles for articles of footwear. In particular, the application relates to wear-resistant unisoles having improved traction.

Articles of footwear, especially footwear for sports, preferably exhibit good traction. Traction under a variety of circumstances may be important. Users of such footwear also seek long-lasting products.

Therefore, there exists a need in the art for wear-resistant articles of footwear having improved traction characteristics.

### SUMMARY

In one aspect, the disclosure relates to a composition comprising the reaction product of an olefin block copolymer, a silicone polymer, a blowing agent, and a crosslinking agent.

In another aspect, the disclosure relates to a unisole for an article of footwear. The unisole may include a foamed olefin block copolymer/silicone polymer blend and may have a plurality of ground-engaging protrusions having a length and recessed portions between the protrusions. The ground-engaging protrusions have a first total area, and the recessed portions have a second total area. The ratio of the first total area to the second total area is between about 45:55 to about 65:35.

In yet another aspect, the disclosure relates to a unisole for an article of footwear. The unisole may include a foamed reaction product of an olefin block copolymer, a silicone polymer, a blowing agent, and a crosslinking agent. The unisole may have a plurality of ground-engaging protrusions have a length and recessed portions between the protrusions. The ground-engaging protrusions having a first total area, and the recessed portions having a second total area. The ratio of the first total area to the second total area is between about 45:55 to about 65:35.

Other systems, methods, features, and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic illustration of a test plaque of a preferred embodiment of the disclosure;

FIG. 2 is a schematic illustration of a test plaque of another preferred embodiment of the disclosure;

FIG. 3 is a schematic illustration of a test plaque of yet another preferred embodiment of the disclosure;

FIG. 4 is a schematic illustration of a test plaque of still another preferred embodiment of the disclosure;

FIG. 5 is a table summarizing the compositions of compounds of embodiments of the disclosure;

FIG. 6 is a summary of properties and characteristics of configurations of embodiments of the disclosure;

FIG. 7 is a graphic representation of the coefficient of traction for embodiments of FIG. 1;

FIG. 8 is a graphic representation of the DIN Values for test plaques of FIG. 1;

FIG. 9 is a graph illustrating some of the properties and characteristics of embodiments of the disclosure; and

FIG. 10 is a schematic illustration of a preferred embodiment of the disclosure.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structure, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure are synonymous.

Embodiments of the disclosure are directed to a composition that provides an improved balance between abrasion resistance and coefficient of traction (CoT). The composition may include a cross-linked foam that may include the reaction product of an olefin block copolymer, a silicone polymer, and a cross-linking agent. The composition may be foamed by a blowing agent during processing. Cross-linking may be achieved by addition of the cross-linking agent during processing. The foam composition may also include a pigment, other additives, and an anti-static agent.

Testing compositions and configurations of protrusions and recessed areas may be carried out on a test plaque. A test plaque may have protrusions and recessed areas between them corresponding to portions of a ground-engaging surface of an article of footwear. Recessed areas devoid of protrusions are not included in any calculations.

The coefficient of traction may be determined by placing a test plaque in a work piece and translating the plaque across a surface. The test plaque is subjected to a vertical force, such as a weight. Then horizontal force is the force required to translate, or slide, the test plaque across a horizontal surface. Herein, the surface is a polished wood floor intended to represent a gymnasium floor on which basketball, handball, volleyball, and other games may be played. The coefficient of traction is the ratio between the horizontal force and the vertical force. Thus, for example, if it takes a 1 kg horizontal force to translate a 10 kg weight, the coefficient of traction is 0.1.

Embodiments of the disclosure may have a coefficient of traction characterized under a variety of conditions. Typically, for a shoe intended to be used on a smooth, wooden floor on which basketball, handball, or volleyball would be played, coefficient of traction may be determined under dry, dusty, or wet conditions. Dry conditions are found on a clean wooden surface devoid of dust and water or other fluids. Dusty conditions are found on a smooth surface devoid of water but covered with a coating of particulate dust. In testing, the dusty coating is essentially evenly distributed over the test area. A dust simulant, some of which are commercially available, may be used. For determination of a wet coefficient of traction, a clean surface is evenly wetted with water.

Typically for embodiments of the disclosure, the coefficient of traction under dusty conditions will be less than that for dry conditions. This is to be expected because dust introduces a loose substance between the test plaque and the testing surface. Wet coefficient of tractions would be expected to be even lower than the dusty coefficients of traction, as the fluid on the surface greatly reduces contact between the test plaque and the testing surface.

Abrasion resistance may be measured by a DIN abrasion test, which measures the quantity of material removed by a standard abrasive from a test plaque within a selected period or distance moved by the abrasive against the test plaque. The test plaque is contacted by moving abrasive with a specified pressure for the prescribed period, and the amount of material removed from the test plaque, measured in mm³, is the result, or the DIN Value. Thus, smaller values of the DIN Value represent better wear resistance.

In embodiments of the disclosure, the olefin block copolymer may be present in an amount of about 75 pounds per hundred pounds of rubber (or resin) (phr).

Olefin block copolymers may include polymers of soft blocks, which provide highly elastomeric functionality to the composition, and hard blocks, which provide rigidity to the composition. The blocks are joined linearly or end to end. In some embodiments, the blocks often are randomly arranged in the olefin block copolymer. However, in embodiments, olefin block copolymers having regularly-alternating, rather than randomly-arranged, hard and soft blocks. The proportions and identities of soft blocks and hard blocks in the olefin block copolymer may differ, depending upon the properties sought. Thus, the blocks may differ in density, crystallinity, tacticity, homogeneity, or any physical or chemical property.

In embodiments of the disclosure, the density of the olefin block copolymer typically ranges from about 0.80 g/cc to about 0.95 g/cc, more typically between about 0.83 g/cc and about 0.92 g/cc, and even more typically between about 0.85 g/cc and about 0.90 g/cc. Density may be between about 0.86 g/cc and about 0.89 g/cc.

In embodiments of the disclosure, the olefin block copolymer may include an ethylene/α-olefin block copolymer. Typically, at least about 50 mol % of olefin block copolymer may include ethylene-containing hard blocks. In some embodiments, the hard blocks may include at least about 95 wt percent ethylene, and may be 100 wt percent ethylene. The ethylene hard blocks may be highly crystalline. The remainder of the olefin block copolymer may be soft blocks of amorphous olefins.

In some embodiments of the disclosure, suitable α-olefin fractions include straight-chain or branched α-olefin having between 3 and about 30 carbon atoms. Embodiments of the disclosure also may include cyclo-olefins having between 3 and about 30 carbon atoms and di- and poly-olefins having at least 4 carbon atoms.

Embodiments of the disclosure also may include blends of olefin block copolymers. Different compositions may be used to achieve different properties and characteristics, such as hardness, resistance to compression set, or resistance to extremes of hot and cold temperature, in the resultant composition. DIN abrasion testing may be used to determine durability or wear resistance. The phrases wear resistance, abrasion resistance, or durability, are used interchangeably herein. Standard coefficient of traction testing may be used to determine traction properties. The identities of the components may be adjusted to adjust these properties and characteristics.

Suitable olefin block copolymer compositions are commercially available from many sources known to practitioners. For example, suitable olefin block copolymers are available from Dow Chemical Company under the tradename INFUSE™ OBC Product, which has regularly-alternating hard and soft blocks. Other products also are available.

In embodiments of the disclosure, silicone rubber may include about 25 phr in the composition. Silicone rubber typically has excellent resistance to compression set. Minor quantities of other polymers also may be included in this 25 phr of rubbers. Silicone rubber has the general formula [—Si(R1)(R2)-OH—Si(R3)(R4)-O]ₙ, wherein m is between 1 and about 20,000 and n is between 1 and 20,000. Often, differences between silicone rubbers are found in the pendant groups, i.e., R1, R2, R3, and R4. In some embodiments, R1, R2, R3, and R4 each may be individually selected from the group consisting of methyl, phenyl, vinyl, trifluoropropyl, and blends thereof, wherein at least one of R1, R2, R3, and R4 is vinyl. In some embodiments, R1, R2, R3, and R4 each may be individually selected from the group consisting of an alkyl, and R1, R2, R3, and R4 may be the same alkyl. Other silicone rubber compositions also are available. In some embodiments, the silicone rubber may be a blend of silicone rubbers having different pendant groups.

To achieve or generate a foam, a blowing agent may be added to the composition. Any suitable blowing agent may be used. A blowing agent is a substance capable of producing a cellular structure via a foaming process in a polymer that undergoes hardening or phase transition. Typically, blowing agents are added to the polymer when the polymer material is in a liquid stage. Blowing agents typically foam the polymer to which it is added by liberating gases while decomposing when heated during processing. Other blowing agents are liquid when added to the polymer, but vaporize when heated during processing. Other blowing agents may include nitrogen and carbon dioxide, which tend to yield high and medium density foams.

Blowing agents may be selected to ensure compatibility of the products of decomposition, or of the vaporized blowing agent, with the polymer being foamed. For example, azodicarbonamide creates nitrogen and ammonia and increases the temperature upon decomposition. Blowing agents that degrade endothermically typically liberate carbon dioxide and create water. If the other components are sensitive to ammonia or water, for example, a different blowing agent may be selected. Blowing agent typically may be present in an amount of between 0.25 phr and about 3.0 phr, and typically between about 1 phr and about 2 phr.

Crosslinking agents may be used in the composition to crosslink polymer chains to improve structural integrity and to provide resistance to chemical attack. Cross-linkers are chemical products that chemically form bonds between two hydrocarbons, which may add rigidity to a product. One such cross-linking agent is BIBP, or bis[1-(tert-butylperoxy)-1-methylethyl]benzene. Dicumyl peroxide also may be used as a cross-linking agent. The reaction is a chemical one and typically can release a small amount of heat or absorb that amount of heat depending on the chemical used. Typically, cross-linking agents may be present in an amount between about 0.5 and 3 phr, typically between about 1 and about 2 phr.

Pigments in the form of fine particulates may be used in quantities up to about 5 phr. In embodiments of the disclosure, titanium oxide may be used as a pigment. Between about 1 and about 10 phr, typically between about 2 phr and 4 phr, of titanium dioxide may be present in embodiments of the disclosure. In some embodiments, zinc oxide in an amount between about 1 phr and about 2 phr also may be used.

In embodiment of the disclosure, the foam composition may include minor amounts of other additives, such as anti-oxidants, viscosity modifiers, fillers, release agents, odor absorbents, and other commonly-used additives. Such additives may be present in any combination and may include other minor additives.

In embodiments of the disclosure, an anti-static agent may be added to adjust properties and characteristics of the foamed composition. Anti-static agents may help to minimize attraction of dust to the surface of the polymer or of an object made with the polymer. Anti-static agents fall generally into three types: migratory additives, ionic (both anionic and cationic) conductors; and particulates such as carbon black. Migratory additives tend to improve performance as time after manufacture increases. Carbon blacks and particulates provide limited resistivity to dust. However, ionic conductors typically provide essentially constant performance at a level far superior to carbon blacks. In embodiments of the disclosure, ionic conductors may be used to reduce static. In particular, octane-1-sulfonates may be added at a level of between about 5 phr and about 15 phr, typically between about 8 phr and about 12 phr. In embodiments of the disclosure, sodium octane-1-sulfonate may be used. Other counter cations, such as potassium, also may be used.

The hardness, wear resistance, coefficient of traction, and other properties and characteristics of the composition may be changed by changing the components of the composition. For example, the composition may be made harder by using an olefin block copolymer comprising more hard blocks. Similarly, different silicone rubbers may change the properties and characteristics of the resultant product. Typically, olefin block copolymers are available in a wide range of properties and characteristics, as are silicone rubbers. In embodiments of the disclosure, properties and characteristics that yield a wear-resistant unisole having improved traction may be favored.

Embodiments of the disclosure may be directed to a wear-resistant polymer providing improved traction in a unisole for an article of footwear. The composition of embodiments of the disclosure of such a polymer set forth above serves as such a composition. Other embodiments are directed to a unisole for an article of footwear. The properties and characteristics of wear resistance, abrasion resistance, or durability, may be tested and compared amongst embodiments of the disclosure by comparing values of the DIN abrasion test. This test measures the volume of composition removed from a mass. Herein, test plaques may be used to represent embodiments of unisoles. Comparison of the values from the test on plural samples of the composition, which may differ in composition or configuration, may illustrate which products and configurations provide a wear-resistant unisole with improved traction.

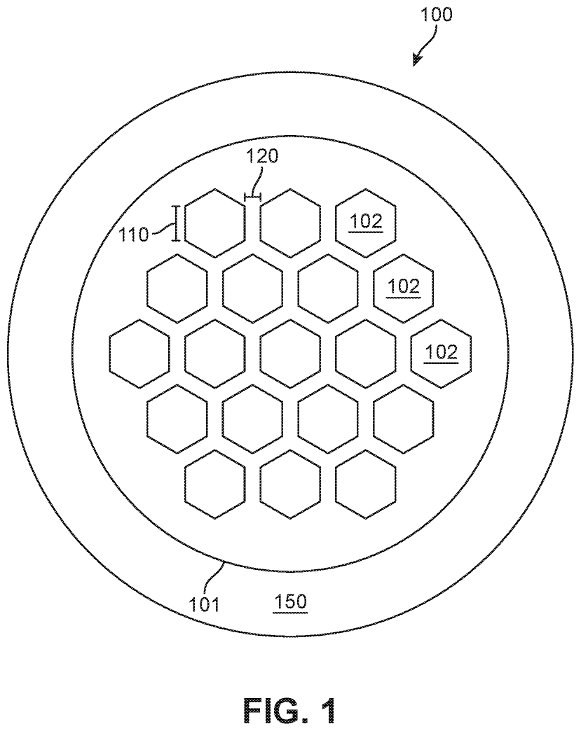

In the illustrated embodiment of FIG. 1, a test plaque representing the ground-engaging portion of a unisole, comprising hexagonal projections or protrusions on a recessed surface is illustrated. Plaque 100 has flange 150 for retention in a testing tool. The surface inside ring 101 provides a recessed surface from which protrusions 102 extend. Each of the hexagons illustrated is such a protrusion. These hexagonal protrusions 102 have a dimension 110, and have recessed areas having a width 120 separating the protrusions from each other. The total area of the protrusions is the sum of the areas of all protrusions 102. The total area of the recessed areas includes only the area of the recessed areas between the protrusions. Recessed surfaces devoid of protrusions are not considered when calculating the area of the recessed areas.

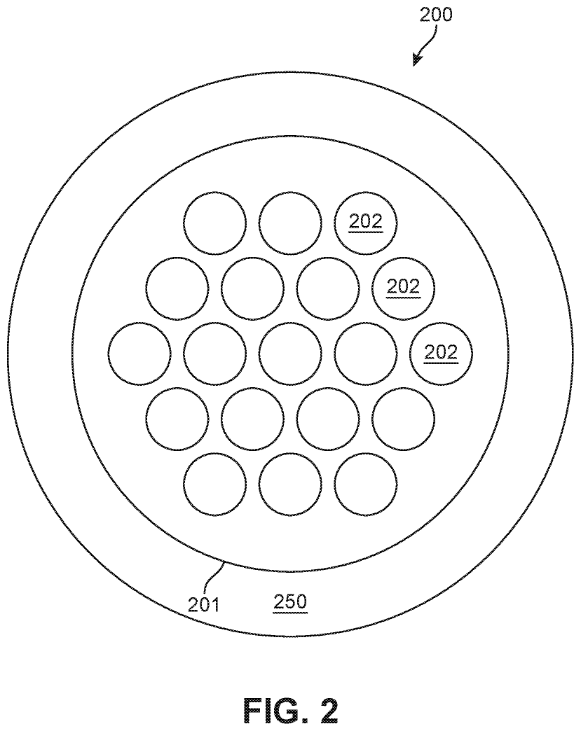

The shape and configuration on the test plaque may be changed to test different embodiments of unisoles of the disclosure. For example, FIG. 2 illustrates embodiments of test plaque 200 including attachment flange 250 and a surface inside ring 201. In these embodiments, protrusions 202 are circular and are separated by recessed areas between them.

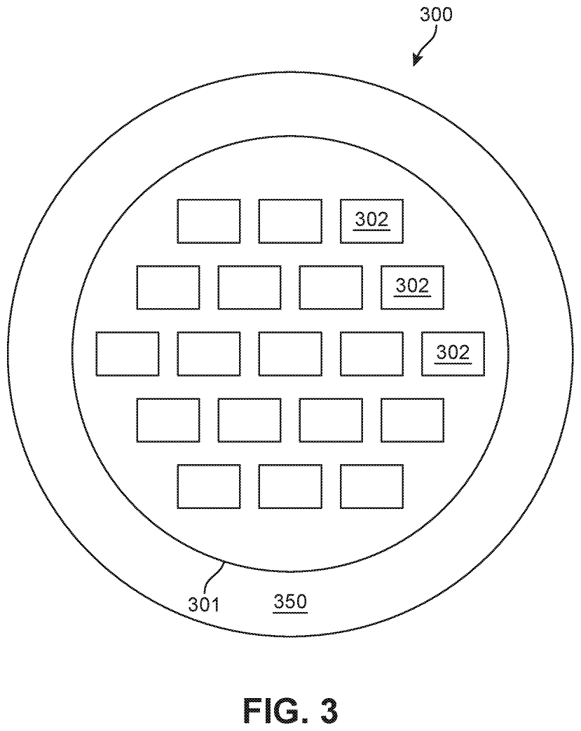

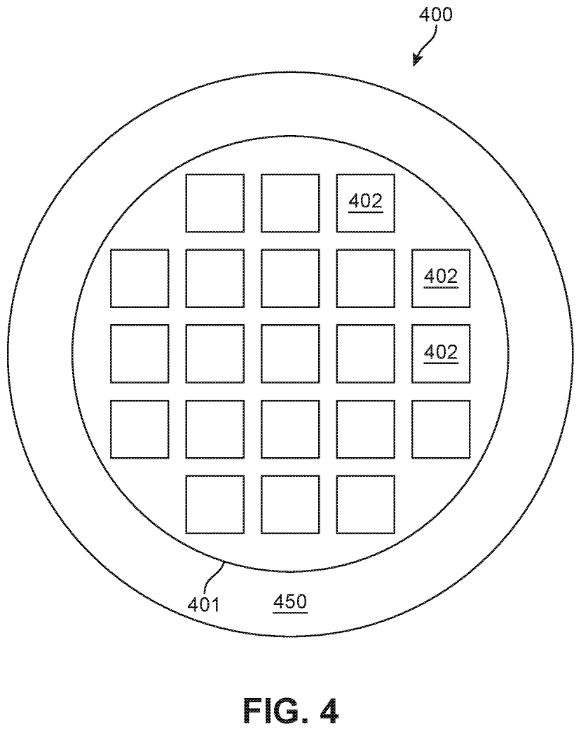

FIG. 3 illustrates embodiments of test plaque 300 including attachment flange 350 and a surface inside ring 301. In these embodiments, protrusions 302 are rectangular, are arranged in an offset or alternating fashion, and are separated by recessed areas between them. FIG. 4 illustrates embodiments of test plaque 400 including attachment flange 450 and a surface inside ring 401. In these embodiments, protrusions 402 are square and are separated by recessed areas between them. The squares also are aligned in both horizontal directions, but they could be offset, like the brick shape.

In embodiments of the disclosure, the size of the protrusions may be changed to provide a desired look or desired style that yields the desired performance characteristics. One may expect that a unisole having the largest protrusions with little recessed area between them might provide the best combination of wear resistance, abrasion resistance, or durability and traction. However, the inventors have discovered that a different combination of protrusions and recessed areas provides superior performance, as set forth in the following example.

In embodiments of the disclosure, wear resistance may be determined by DIN abrasion tests, and traction may be related to a coefficient of traction. The result may be expressed in numerical values and also may be expressed graphically.

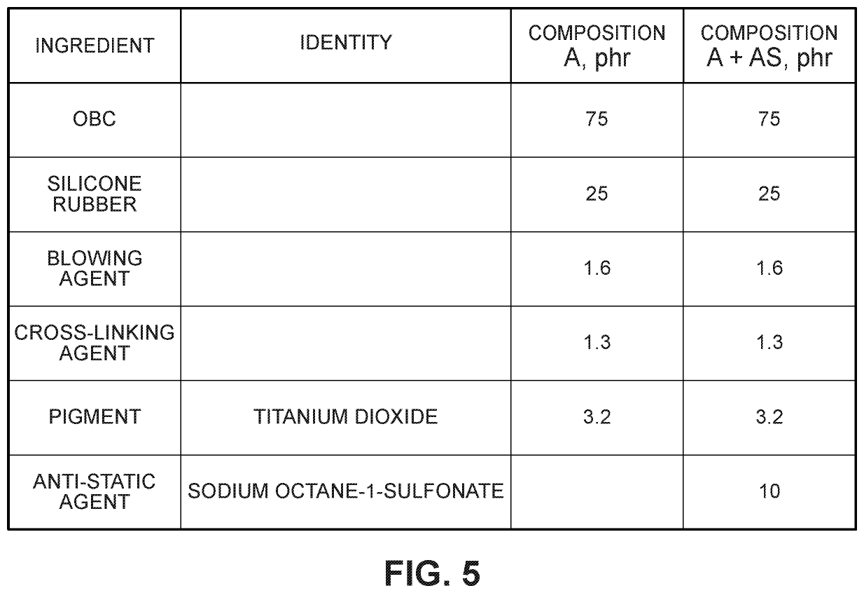

The compositions described in FIG. 5 were tested in various configurations. As can be seen, the compositions differed only in whether an anti-static agent was present.

Six versions of the test plaque illustrated in FIG. 1 were tested with the two compositions identified in FIG. 5. The six versions differed in the width of the recessed areas and the size of the protrusions. The size of the area in which the protrusions were evenly distributed remained unchanged.

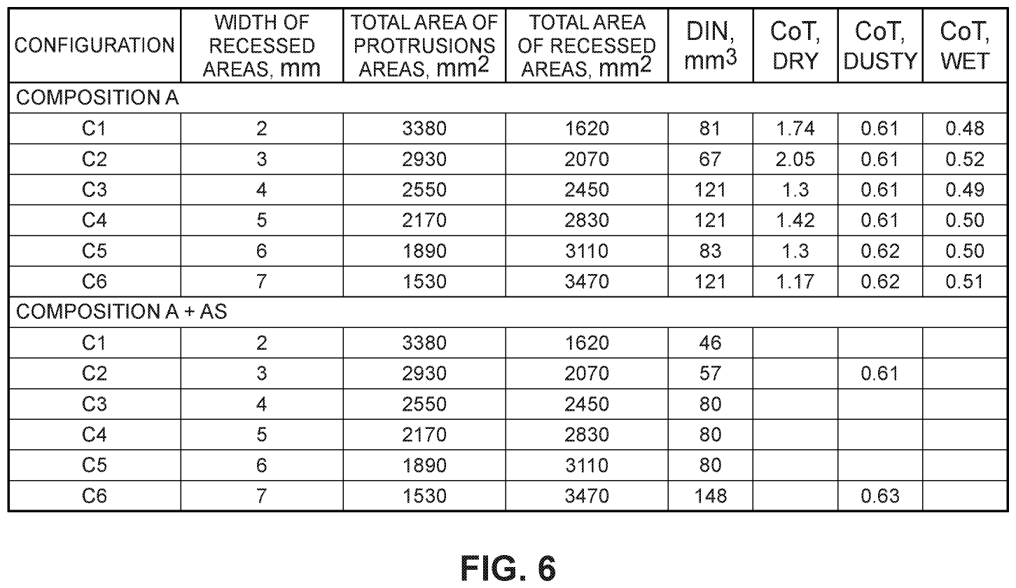

FIG. 6 summarizes the properties and characteristics of six configurations of test plaques. The test plaques represented the ground-engaging portion of a unisole for an article of footwear. In an article of footwear, there may typically be an upper, an insole or a sock liner, a midsole, and an outsole. A unisole serves the function of the midsole and the outsole combined. Thus, the unisole serves to both cushion the foot and provide a wear-resistant ground-engaging surface that has an improved coefficient of traction. The olefin block copolymer component tends to provide cushioning while the silicone rubber resists compression set.

The six configurations may be arranged by the width of the recessed areas between the hexagonal protrusions. For example, C1 has recessed areas 2 mm wide, and C2 has recessed areas 3 mm wide. As the total area available remained constant at 5000 mm³, wider recesses required smaller hexagonal protrusions. FIG. 6 further summarizes the areas relevant to calculation of the ratio of the total area of the protrusion areas to the total area of the recessed areas, i.e., the Area Ratio.

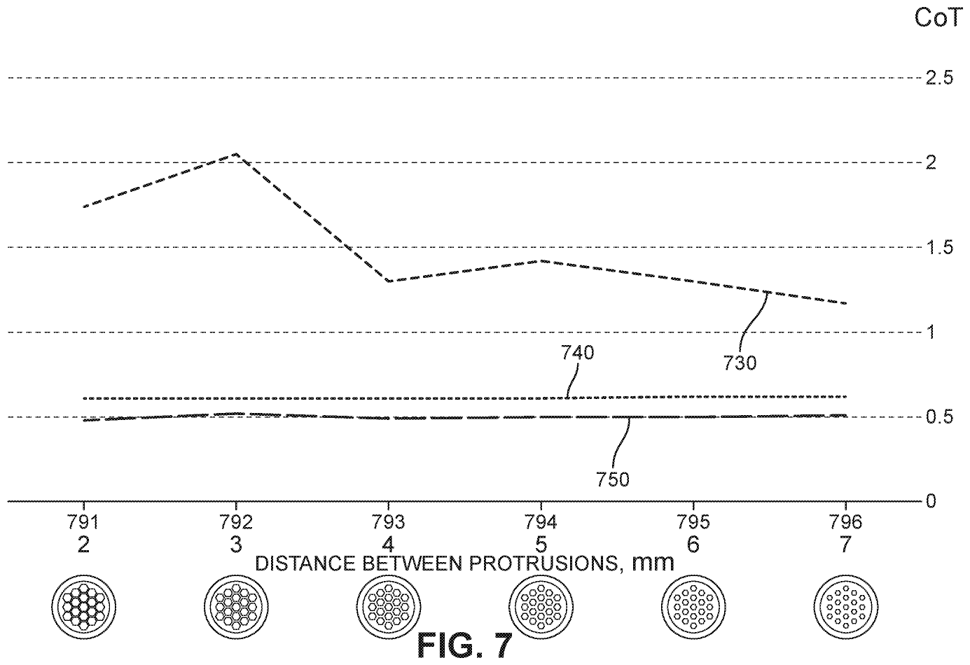

FIG. 6 summarizes the results of DIN testing for each configuration and for both compositions described in FIG. 5. The results of three coefficient of traction test series also are set forth in FIG. 6. The plaques were tested to determine coefficient of traction under three conditions: dry, dusty, and wet. The sample under testing was placed in a work piece and translated across a surface to determine the coefficient of traction. The resultant coefficient of traction data is set forth graphically in FIG. 7 as a function of the configuration, i.e., the width of the recessed areas.

FIG. 7 graphically illustrates the coefficient of traction, wet, for Composition A, as line 750. The coefficient of traction for Composition A under dusty conditions is illustrated as line 740. These lines are presented to illustrate the levelling effect on other-than-dry conditions have on the coefficient of traction. Further, the coefficient of traction data for dusty conditions in FIG. 6 show that the coefficient of traction was essentially the same for both Composition A and Composition A+AS for C2 (both coefficients of traction were 0.61) and for C6 (0.62 vs 0.63). Therefore, line 750 is considered to illustrate the coefficient of traction, wet, for Composition A+AS, and line 740 is considered to illustrate that the coefficient of traction, dusty, for Composition A+AS.

Because the comparable dusty coefficients of traction for both compositions were essentially equal, the dry coefficients of traction for both compositions are considered to be equal. Thus, line 730 on FIG. 7 illustrates the dry coefficient of traction for both compositions.

For convenience, illustrations depicting the relative proportions of the protrusion areas and the recess areas are set forth at the bottom of FIG. 7.

Line 730 on FIG. 7 illustrates some anomalies in the dry coefficient of traction for Composition A (which also reflects the value for Composition A+AS). In the plaques illustrated in FIG. 7, the coefficient of traction does not decrease as the width of the recessed areas increases from C1 to C6.

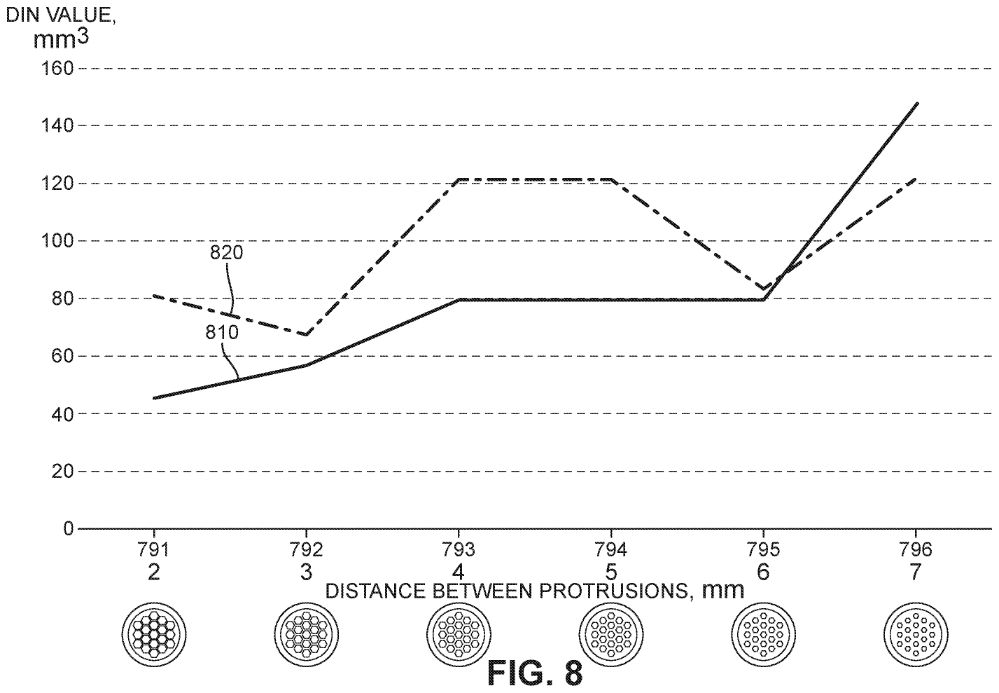

The six configurations also were subjected to the DIN Abrasion test to determine wear resistance. The DIN values, or result, measures the volume of material removed from the test plaque under a specified stress and for a period. Thus, the higher the DIN value, measured in mm³, the lower the wear resistance. The hexagonal protrusions were 3 mm high. The data is summarized graphically in FIG. 8 as functions of the configuration, as for FIG. 7.

Looking now to FIG. 8, line 820 plots the DIN Abrasion results for Composition A, and line 810 plots the DIN Abrasion results for Composition A+AS. FIG. 8 illustrates a somewhat surprising result for the DIN values on line 810 for composition A+AS. The DIN values generally trend up, as may be expected, from C1 to C3, remain constant to C5, and then increase to C6, i.e., from highest to lowest Area Ratio. The DIN values for Composition A, on line 820, are less regular. The DIN value decreases from C1 to C2, increases to C3, plateaus at C4, and dips at C5 and returns to a higher value at C6. FIG. 8 also includes the illustrations of relative proportions of areas.

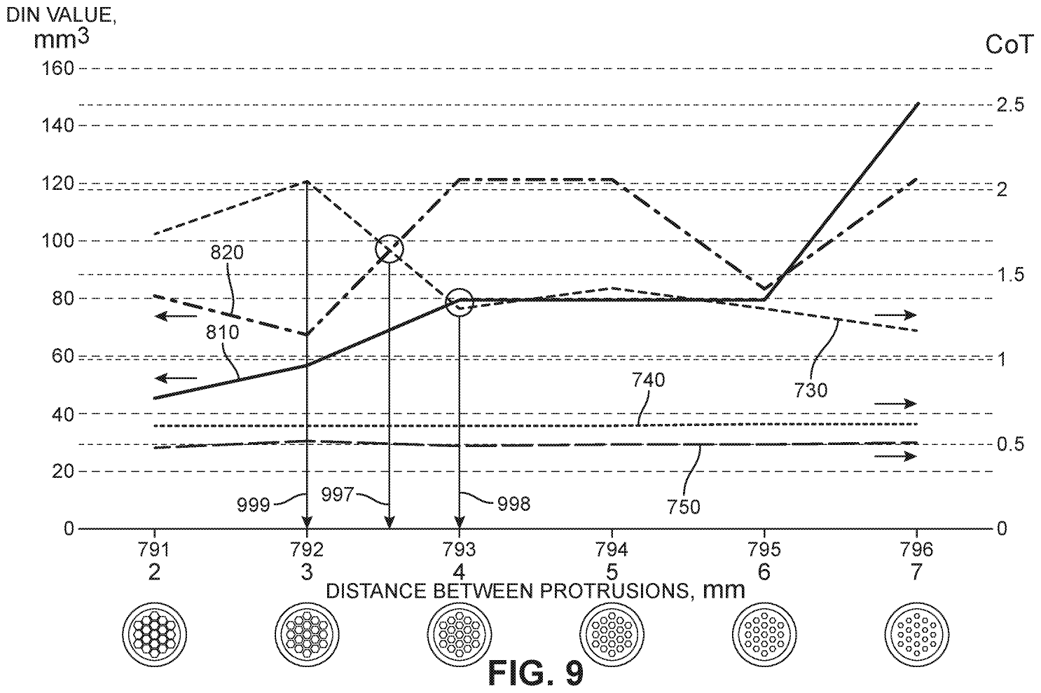

FIG. 9 is a combination of FIG. 7, FIGS. 8, and 9. On each of FIG. 7, FIG. 8, and FIG. 9, the relative proportions of protrusion area and recess area are illustrated schematically in small circles below the graph.

The data in FIG. 6 showed the coefficient of traction for the dusty samples of C2 and C6 were essentially the same, with no benefit for Composition A+AS, i.e., the composition with anti-static agent, over Composition A, which did not contain anti-static. Further, the coefficient of traction for wet samples were essentially the same. Therefore, the dry coefficient of traction for each configuration was considered to be essentially the same for both compositions.

FIG. 9 is a combination of FIG. 7, FIGS. 8, and 9. On each of FIG. 7, FIG. 8, and FIG. 9, the relative proportions of protrusion area and recess area are illustrated schematically in small circles below the graph. Line 730, line 740, and line 750, which relate to coefficient of traction, are read on the right scale. Line 810 and 820, plots of DIN values, are to be read on the left scale.

The various configurations are identified on each of FIG. 7, FIG. 8, and FIG. 9. As can be seen, C1 is illustrated at point 791, C2 is illustrated at point 792, C3 is at point 793, C4 is at point 794, C5 is at point 795, and C6 is at point 796.

The plot of coefficient of traction, wet, for Composition A is illustrated by line 750, and line 740 illustrates the coefficient of traction for dusty conditions for Composition A. These values are presented to illustrate the levelling effect non-dry conditions have on coefficient of traction.

The following examples of the invention are intended to illustrate the disclosure, and not to limit the claims in any way.

### Example 1—High Coefficient of Traction and Low DIN

FIG. 9 may be used to illustrate that point 792, indicated by pointer 999, had the highest coefficient of traction (2.05; line 730) and lowest DIN value for Composition A (67; line 820), and so provided a wear-resistant product with improved traction. Point 792 also provided a reasonable balance for properties for Component A+AS, as the DIN value of 57 (line 810) is but slightly higher than the lowest value. Thus, even though C1, point 791, yielded a better DIN value for Composition A+AS, the lower coefficient of traction for C1 made C2, point 792, an unexpectedly better choice for a wear-resistant unisole having improved traction, in accordance with the disclosure.

### Example 2—Moderate Coefficient of Traction and DIN

The circle at the end of pointer 998 illustrates a point where the DIN for Composition A+AS was 80 (line 810) and the coefficient of traction under dry conditions was about 1.3 (line 730). Thus, pointer 998 identified a point at which Composition A+AS provided a balanced product that exhibits excellent wear resistance and dry coefficient of traction. Pointer 998 identifies point 793, which corresponds with C3, or the configuration with 4 mm between protrusions. Pointer 998 also indicates a DIN value for Component A that provided a reasonable balance between wear resistance and coefficient of traction.

### Example 3—Low Coefficient of Traction and Low DIN

Another balance of wear resistance and coefficient of traction is found at the point illustrated by the circle at the top of pointer 997. This circle identified the DIN value of 96 for Composition A, and the dry coefficient of traction of 1.62. Such products of the disclosure provide a wear-resistant product having improved traction. The DIN value for Composition A+AS was 68.

Thus, the products that have the best balance of wear resistance and improved traction unexpectedly are not the products that have the greatest proportion of area of protrusions to area of recesses. Rather, Example 1, Example 2, and Example 3 illustrate the best balance between wear resistance and traction.

Typically, in embodiments of the disclosure, a unisole may be manufactured from an embodiment of a composition disclosed herein by injection molding. In injection molding, the components of the composition may be blended and reacted in an extruder, which liquefies the components and activates the cross-linking agent and the blowing agent, and perhaps other components, to form a foamed composition that is the reaction product of the components. Components may be added at different times or points during extrusion. For example, blowing agent may be added toward the end of the reaction. The liquid foam then may be injection molded to form a unisole.

As discussed above, the protrusions on the ground-engaging portion of the unisole may be of any shape. Also, the protrusions may be of any length. Typically, the shape and length may be selected to provide particular traction characteristics. Often, the wearer's perceptions of the traction characteristics may be just as important as rigorously measured characteristics. For example, whereas C2, point 792, had the highest coefficient of traction, both dry and wet, and a coefficient of traction under dusty conditions that was on par with the other configurations, for Composition A, it also had the largest difference in coefficient of tractions between dry and dusty conditions. If a wearer is able to perceive this difference, it may be useful to provide an article of footwear that has smaller differences between the coefficients.

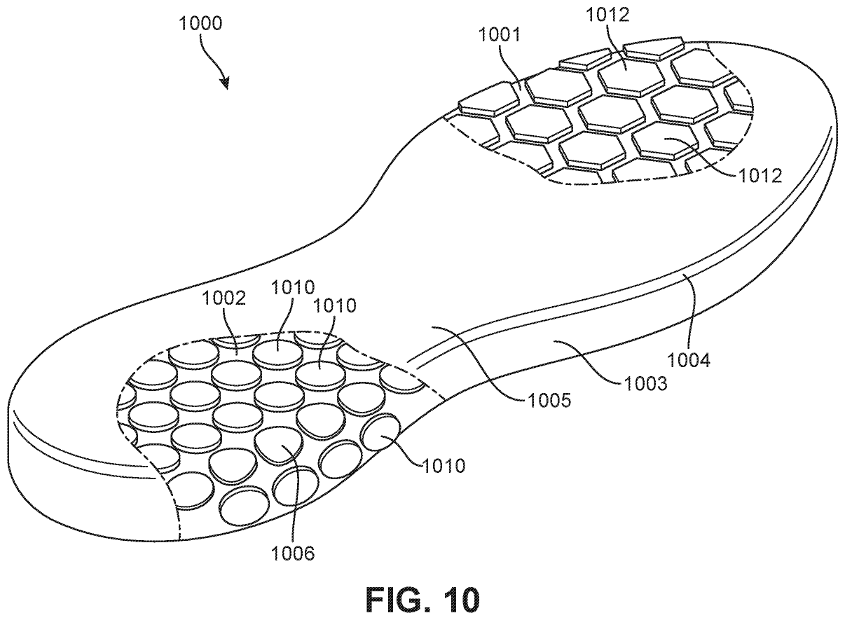

As illustrated in FIG. 10, regions of embodiments of unisole 1000 may have protrusions of different size and shape. As shown in FIG. 10, unisole 1000 has a region on the forefoot portion of the unisole of hexagonal protrusions 1012 having recessed area 1001 between them. On the heel portion, circular protrusions 1010 may appear on the ground-engaging portion or on the side 1003 of unisole 1000. Circular protrusion 1006 wraps around the edge 1004 of unisole 1000. Protrusions 1010 have recessed area 1002 between them. FIG. 10 further illustrates an embodiment in which midsole 1005 is devoid of protrusions.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A composition comprising the reaction product of:
an olefin block copolymer;
a silicone polymer;
a blowing agent; and
a crosslinking agent.

2. The composition of claim 1, further comprising an ionic conductor anti-static agent.

3. The composition of claim 2, wherein the ionic conductor anti-static agent comprises an octane-1-sulfonate.

4. The composition of claim 1, wherein the olefin block copolymer is an ethylene/olefin block polymer.

5. The composition of claim 4, wherein the olefin is an α-olefin having between 3 and about 30 carbon atoms.

6. The composition of claim 1, wherein the composition comprises about 75 phr olefin block copolymer.

7. The composition of claim 1 wherein the silicone polymer is present in an amount of 25 phr.

8. The composition of claim 1, wherein the composition is a foam having a density of between about 0.2 and about 0.3 g/cc.

9. A unisole for an article of footwear, the unisole comprising a foamed olefin block copolymer/silicone polymer blend; the unisole comprising:
a plurality of ground-engaging protrusions having a length and recessed portions between them;
the ground-engaging protrusions having a first total area;
the recessed portions having a second total area;
wherein the ratio of the first total area to the second total area is between about 45:55 to about 65:35.

10. The unisole of claim 9, wherein the ration of the first total area to the second total area is between about 50:50 to about 60:40.

11. The unisole of claim 9, wherein the length of the protrusions is between about 0.5 mm and about 8 mm.

12. The unisole of claim 11 wherein the length of the protrusions is between about 2 mm and 5 mm.

13. The unisole of claim 9, wherein the foamed olefin block copolymer/silicone polymer blend comprises about 75 phr olefin block copolymer and about 25 phr silicone polymer.

14. A unisole for an article of footwear, the unisole composition comprising the foamed reaction product of:
an olefin block copolymer;
a silicone polymer;
a blowing agent; and
a crosslinking agent;
wherein the unisole comprises
a plurality of ground-engaging protrusions having a length and recessed portions between them;
the ground-engaging protrusions having a first total area;
the recessed portions having a second total area;
wherein the ratio of the first total area to the second total area is between about 45:55 to about 65:35.

15. The unisole of claim 14, wherein the unisole composition further comprises an ionic conductor anti-static agent.

16. The unisole of claim 15, wherein the ionic conductor anti-static agent comprises an octane-1-sulfonate.

17. The unisole of claim 14, wherein the foamed olefin block copolymer/silicone polymer blend comprises about 75 phr olefin block copolymer and about 25 phr silicone polymer.

18. The unisole of claim 14, wherein the ratio of the first total area to the second total area is different on different regions of the unisole.

19. The unisole of claim 14, wherein the protrusions have different shapes on different regions of the unisole.

20. The unisole of claim 14, wherein the length of the protrusions is between about 2 mm and 5 mm.
